(19) United States
(12) Patent Application Publication
(10) Pub. No.: US 2012/0248654 A1
(43) Pub. Date: Oct. 4, 2012

(54) INJECTION MOLDING SYSTEM WITH MULTIPLE ACCUMULATOR ASSEMBLIES

(75) Inventors: Trevor Paul Van Eerde, Innisfil (CA); Miroslaw Kowalczyk, Missisauga (CA)

(73) Assignee: Husky Injection Molding Systems Ltd., Bolton (CA)

(21) Appl. No.: 13/513,245

(22) PCT Filed: Nov. 11, 2010
(86) PCT No.: PCT/CA2010/001754

§ 371 Date: Jun. 1, 2012

Related U.S. Application Data
(60) Provisional application No. 61/289,031, filed on Dec. 22, 2009.

(51) Int. Cl. B29C 45/67; B29C 47/92; B29C 45/18

(52) U.S. Cl. 264/328.19; 425/557; 425/147

(57) ABSTRACT

An injection molding system (20) is provided including an extruder unit (22) having an injection actuator (38) for injecting a melt into a mold assembly (40); and a clamping unit (24), the clamping unit (24) configured to retain the mold assembly (40) during injection. A power pack (46) is provided, including a fixed-target accumulator assembly (62) operable to discharge hydraulic fluid at a fixed hydraulic pressure to the clamping unit (24) and a first pump being connected with the clamping unit (24), the first pump operable for charging the fixed-target accumulator assembly (62) to the fixed hydraulic pressure. The power pack (46) also includes a variable-target accumulator assembly (66) operable to discharge hydraulic fluid at a variable hydraulic pressure to the injection actuator (38) during the molding cycle; and a second pump connected to the variable-target accumulator assembly (66), the second pump operable for charging the variable-target accumulator assembly (66) to the variable hydraulic pressure.

### TECHNICAL FIELD

The present relates to injection molding systems. More specifically, the present relates to a an injection molding system having multiple accumulator assemblies.

### BACKGROUND

Some examples of known injection molding systems are: (i) the HyPET™ Molding System, (ii) the Quadloc™ Molding System, (iii) the Hylectric™ Molding System, and (iv) the HyMet™ Molding System, all manufactured by Husky Injection Molding Systems, Ltd. of Bolton, Ontario, Canada. These injection molding systems includes components that are known to persons skilled in the art and these known components will not be described here; these known components are described, by way of example, in the following references: (i) Injection Molding Handbook by Osswald/Turng/Gramann ISBN: 3-446-21669-2; publisher: Hanser, and (ii) Injection Molding Handbook by Rosato and Rosato ISBN: 0-412-99381-3; publisher: Chapman & Hill. Injection molding systems typically include hydraulic actuators to motive a movable platen and a reciprocating screw. Hydraulic power is typically provided by a power pack which can include a motor-driven hydraulic pump, and hydraulic accumulators.

U.S. Pat. No. 6,478,572 to Shad (issued 12 Nov. 2002) teaches an energy efficient drive system is provided for use on typical injection molding machines whereby a single electric motor drives both the extruder screw and a hydraulic motor that continuously charges a hydraulic accumulator during the extrusion process. During the injection cycle, the charge in the accumulator is directed to stroke the extruder screw and inject melt into the mold cavities. Another embodiment utilizes a similar arrangement on the clamp mechanism of the injection molding machine whereby the charge in the accumulator is directed to hold the mold closed during the injection cycle.

U.S. Pat. No. 5,502,909 to Hertzer (issued 1 Oct. 1991) teaches a hydraulic injection molding machine incorporates a pump driven by a variable speed motor preferably of the brushless DC type. The machine controller outputs driving signals to adjust the speed of the motor so that the flow delivered by the pump substantially matches the hydraulic demand imposed during each phase of the machine operating cycle. The pump is preferably a variable displacement type and is connected to a fast responding pump control for selectively carrying out pressure compensation or flow compensation. The values of the motor driving signals are calculated so that the motor/pump combination is operated at or near maximum efficiency except when the pump control varies the displacement of the pump to effect pressure or flow compensation. Hydraulic transient response is further improved by connecting the output of the pump to an accumulator by way of a check valve.

### SUMMARY

According to an aspect of the illustrated embodiments, there is provided an injection molding system, comprising:
an extruder unit for plasticizing a melt, the extruder unit having an injection actuator for injecting the melt into a mold assembly;
a clamping unit, the clamping unit being configured to retain the together during injection of the melt into the mold assembly; and
a power pack for motivating hydraulic components of the injection molding system during an molding cycle; wherein the power pack includes:
   a fixed-target accumulator assembly operable to discharge hydraulic fluid at a fixed hydraulic pressure to at least one hydraulic component of the clamping unit during the molding cycle;
   a first pump being connected with the clamping unit, the first pump operable for charging the fixed-target accumulator assembly to the fixed hydraulic pressure;
   a variable-target accumulator assembly operable to discharge hydraulic fluid at a variable hydraulic pressure to the injection actuator during the molding cycle; and
   a second pump connected to the variable-target accumulator assembly, the second pump operable for charging the variable-target accumulator assembly to the variable hydraulic pressure.

According to another aspect of the disclosed embodiments, a method is provided for operating an injection molding system during a molding cycle, comprising:
motivating an at least one hydraulic component of a clamping unit of the injection molding system using a first pump;
motivating an injection actuator of an extruder unit using a second pump;
discharging a hydraulic fluid stored at a fixed hydraulic pressure from a fixed-target accumulator assembly to help motivate the at least one hydraulic component of the clamping unit during the molding cycle;
discharging the hydraulic fluid stored at a variable hydraulic pressure from a variable-target accumulator assembly to help motivate the injection actuator during the molding cycle;
recharging the fixed-target accumulator assembly to the fixed hydraulic pressure using the first pump when the first pump has spare pumping capacity during the molding cycle; and
recharging the variable-target accumulator assembly to the variable hydraulic pressure using the second pump when the second pump has spare pumping capacity during the molding cycle.

### DETAILED DESCRIPTION OF THE DRAWINGS

Embodiments will now be described with reference to the accompanying drawings in which:

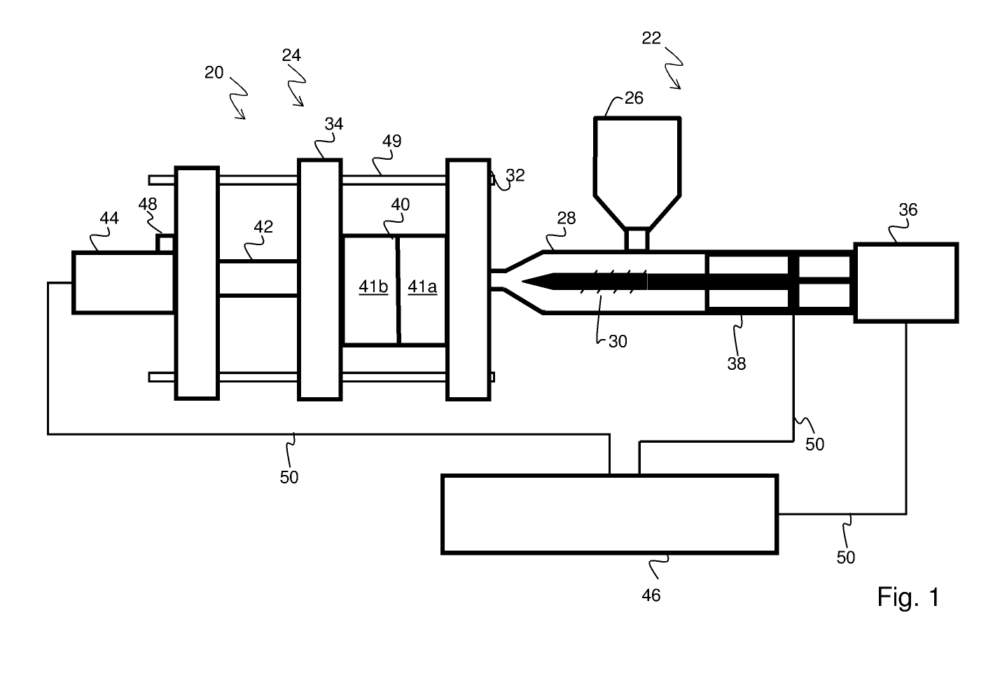

FIG. 1 is a side view of an injection molding system;

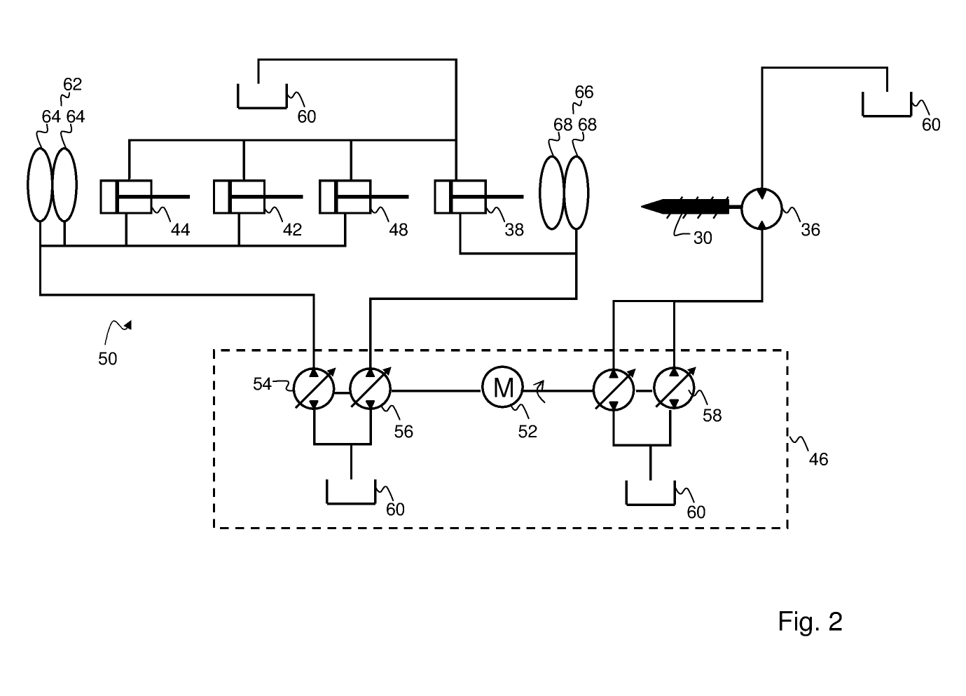

FIG. 2 is a hydraulic schematic of a hydraulic circuit for the injection molding system shown in FIG. 1; and

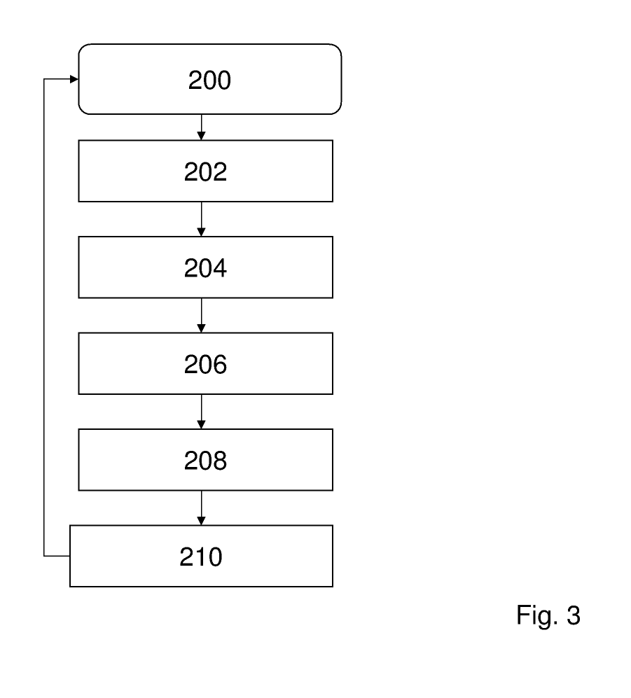

FIG. 3 is a flowchart of a method for operating the injection molding system and hydraulic circuit of FIGS. 1-2 through an molding cycle.

### DETAILED DESCRIPTION OF THE EMBODIMENTS

Referring now to FIG. 1, an embodiment of an injection molding system is shown generally at 20. Injection molding system 20 includes an extruder unit 22 and a clamping unit 24, the extruder unit 22 and the clamping unit 24 being operable to cooperate and produce a molded article (not shown). The extruder unit 22 and the clamping unit 24 each include at least one hydraulic component (described in greater detail below).

The extruder unit 22 includes a hopper 26, attached to a barrel 28. A reciprocating screw 30 is rotatably and translatably located within the barrel 28, and is operable to plasticize and express resin within barrel 28. The hopper 26 is coupled to a feed throat of the extruder unit 22 so as to deliver pellets of moldable material to the extruder unit 22. The extruder unit 22 is configured to: (i) process the pellets into an injectable molding material, and (ii) inject the injectable material into the clamping unit 24. An HMI (not shown) is coupled to control equipment, and is used to assist an operator in monitoring and controlling operations of the injection molding system 20. In the presently-illustrated embodiment, reciprocating screw 30 is rotated by a screw motor 36, and translated by an injection actuator 38. In the presently-illustrated embodiment, both screw motor 36 and injection actuator 38 are hydraulic components. Although extruder unit 22 is presently-illustrated as containing a reciprocating screw, the extruder unit 22 could alternatively be a two stage injection unit having a non-translating screw or screws and a shooting pot piston that is translated by the injection actuator 38.

The clamping unit 24 includes a stationary platen 32, and a movable platen 34. The stationary platen 32 is configured to support a stationary mold half 41a of a mold assembly 40. The movable platen 34 is configured to: (i) support a movable mold half 41b of the mold assembly 40, and (ii) move relative to the stationary platen 32 so that the mold portions of the mold assembly 40 may be separated from each other or closed together. Another hydraulic actuator, hereafter referred to as the mold stroke actuator 42, is used to stroke the movable platen 34 relative to the stationary platen 32 along a set of tie bars 49. When the mold assembly 40 is closed, another hydraulic actuator, namely clamp lock actuator 48 is used to lock the position of the movable platen 34 relative to the stationary platen 32. Clamping force is provided by a clamp actuator 44, which in the presently-illustrated embodiment, is also a hydraulic component.

Motive power for mold stroke actuator 42, clamp actuator 44, clamp lock actuator 48, injection actuator 38 and screw motor 36 is provided by a power pack 46, and distributed to the various actuators and motors by a hydraulic circuit 50. Referring now to FIG. 2, power pack 46 and hydraulic circuit 50 are described in greater detail. Power pack 46 includes a pump motor 52. The implementation of pump motor 52 is not particularly limited and can include both AC and DC motors in both unidirectional and bidirectional configurations. In the currently-illustrated embodiment, pump motor 52 operates in a single direction at constant speeds throughout the molding cycle (which is described in greater detail below).

Pump motor 52 is operably coupled to drive one or more hydraulic pumps that are connected via hydraulic circuit 50 to a reservoir tank 60. In the presently-illustrated embodiment, pump motor 52 is operably connected to a first pump, namely a clamp pump 54 and a second pump, namely an injection pump 56. As will be described in greater detail below, clamp pump 54 is a variable displacement pump that is operably connected via hydraulic circuit 50 to selectively actuate the mold stroke actuator 42, the clamp lock actuator 48 and the clamp actuator 44. In the presently-illustrated embodiment, clamp pump 54 is a variable displacement pump, operable to have its displacement be adjusted mechanically. Injection pump 56 is a variable displacement pump that is operably connected via hydraulic circuit 50 to selectively actuate the injection actuator 38. In the presently-illustrated embodiment, injection pump 56 is an is a variable displacement pump, operable to have its displacement be adjusted electronically. Hydraulic fluid released from either mold stroke actuator 42, clamp actuator 44, clamp lock actuator 48 or injection actuator 38 is returned to reservoir tank 60 for filtration and cooling prior to being recirculated through hydraulic circuit 50.

Pump motor 52 is further operably connected to one more screw pumps 58, and in the currently-illustrated embodiment, is operably connected to two screw pumps 58. Both screw pumps 58 are variable displacement pumps that are operably connected via hydraulic circuit 50 to drive the screw motor 36. Hydraulic fluid passing through the two screw pumps 58 is returned to reservoir tank 60 for filtration and cooling prior to being recirculated through hydraulic circuit 50. Although screw pumps 58 are currently-illustrated as being separate from screw motor 36, those of skill in the art will recognize that the pumps and screw motor functions can be combined in a single unit.

Clamp pump 54 is further operably connected, via hydraulic circuit 50, to a fixed-target accumulator assembly 62, that comprises one or more accumulators 64, and in the presently-illustrated embodiment includes a plurality of accumulators 64. Each accumulator 64 is charged with hydraulic fluid by clamp pump 54 to a fixed target for hydraulic pressure (such as 220 bar) when the connected actuators are not utilizing the full pumping capacity of their respective pumps. Fixed-target accumulator assembly 62 is adapted to discharge the hydraulic fluid at the fixed hydraulic pressure to mold stroke actuator 42, clamp actuator 44 or clamp lock actuator 48 as is required to improve machine performance.

Injection pump 56 is operably connected, via hydraulic circuit 50, to a variable-target accumulator assembly 66, that comprises one or more accumulators 68, and in the presently-illustrated embodiment, includes a plurality of variable pressure accumulators. Variable-target accumulator assembly 66 is adapted so that injection pump 56 can be charging one or more of the accumulators 68 with hydraulic fluid to any pressure within its operational tolerances (such as up to 220 bar) when the injection pump 56 is not being fully utilized by injection actuator 38. Variable-target accumulator assembly 66 can subsequently discharge the hydraulic fluid from the accumulators 68 at the variable hydraulic pressure.

Those of skill in the art will appreciate that the schematic for hydraulic circuit 50 shown in FIG. 2 is highly simplified and omits control and shutoff valves for the actuators and/or accumulators, pilot lines, controllers, relief valves, gauges, etc. In addition, the controllers used for regulating the control and shutoff valves, etc. are also not explicitly shown.

The pressure stored in the accumulators 68 of the variable-target accumulator assembly 66 can vary, based upon the difference of the requirements of the mold assembly 40, the duration of the molding cycle (i.e., shorter molding cycles require higher pressure), and the output capacity of injection pump 56. The initial pressure value for accumulators 68 can be determined by an operator using the HMI, or a predetermined value stored in memory located on the extruder unit 22, the clamping unit 24, or on the mold assembly 40. Alternatively, the predetermined hydraulic pressure value can be retrieved across a network from a remote site (not shown).

Once operation of the extruder unit 22 has commenced, the injection molding system 20 would use a closed-loop control to determine how much pressure is required (based upon the operation requirements of injection molding system 20) to be stored in variable-target accumulator assembly 66 to meet the performance requirements of the molding cycle. Closed-loop control could be based upon position of reciprocating screw 30 over time during the molding cycle (position control), the instant velocity of reciprocating screw 30 over time (velocity control) or based upon pressure measured in either the barrel 28 or in the injection actuator 38 (pressure control), or by a combination of two or more of position control, velocity control and pressure control. If there is surplus hydraulic pressure being provided by the variable-target accumulator assembly 66, then the output of injection pump 56 while it is recharging the accumulators 68 can be reduced accordingly so that the hydraulic fluid being stored therein is stored at a reduced variable hydraulic pressure. Closed-loop control can be applied at an interval of individual molding cycles, for example, at the end of each molding cycle or between each molding cycle. Alternatively, closed-loop control can have a shorter interval and be applied throughout each step of the molding cycle (described in greater detail below).

Referring now to FIG. 3, a method of operation of injection molding system 20 is shown generally beginning at step 200 for mold close. Throughout the method, pump motor 52 operates at a fixed speed to drive the hydraulic components such as mold stroke actuator 42, clamp actuator 44, clamp lock actuator 48 and screw motor 36. At step 200, mold closing is initiated. Clamp pump 54 actuates the mold stroke actuator 42 to bring the mold halves 41a and 41b together. During this period, injection pump 56 is recharging the variable-target accumulator assembly 66 to the variable hydraulic pressure.

Once the mold-closing operation is complete, the method advances to step 202 for clamp up. Once the mold halves 41a and 41b are closed, clamp pump 54 actuates the clamp lock actuator 48 and then clamp actuator 44 to generate clamp tonnage. To accelerate the clamp locking and the generation of clamp tonnage, fixed-target accumulator assembly 62 provides additional fluid to either clamp lock actuator 48 or clamp actuator 44 at the fixed hydraulic pressure. During this period, injection pump 56 is recharging the variable-target accumulator assembly 66 to the variable hydraulic pressure.

Once clamp-up has occurred, the method advances to step 204 and injection is initiated. Injection actuator 38 translates reciprocating screw 30 to inject the plastic resin into the mold assembly 40. After the mold assembly 40 has been substantially filled with resin, reciprocating screw 30 may continue to apply pressure. To accelerate the injection stroke of reciprocating screw 30, variable-target accumulator assembly 66 provides additional hydraulic fluid to the injection actuator 38 at the variable hydraulic pressure. During this period, clamp pump 54 is recharging the fixed-target accumulator assembly 62 to the fixed hydraulic pressure.

Once melt injection has been completed, the method advances to step 206, where recovery begins (i.e., reciprocating screw 30 retracts and begins to prepare new resin for the next molding cycle). To retract the reciprocating screw 30 during recovery, the injection actuator 38 is allowed to drain to reservoir tank 60 and the pressure of the melt within barrel 28 forces the reciprocating screw 30 to retract. During this period, clamp pump 54 is recharging the fixed-target accumulator assembly 62 to the fixed hydraulic pressure.

Once the molded articles within the mold assembly 40 have cooled sufficiently, the method advances to step 208 for clamp release. Clamp lock actuator 48 and clamp actuator 44 are disengaged, thereby reducing clamp tonnage and disengaging the clamp locks. During this period, injection pump 56 is recharging the variable-target accumulator assembly 66 to the variable hydraulic pressure.

The method then advances to step 210 where the mold assembly 40 is opened. Clamp pump 54 actuates the mold stroke actuator 42 to separate the mold halves 41a and 41b. During this period, injection pump 56 is recharging the variable-target accumulator assembly 66 to the variable hydraulic pressure. The molded articles can be subsequently removed from the mold assembly 40. Once the molded articles have been removed, the injection molding system 20 is ready for another molding cycle and the method returns to step 200.

Although the method described generally in steps 200 to 210 has been shown to be sequential, those of skill in the art will recognize that some overlap of steps will occur for some applications. For example, the injection of melt into the mold assembly 40 (step 204) can sometimes begin before clamp tonnage has been fully generated (step 202). Alternatively, the recovery phase (step 206) can overlap the clamp release (step 208) and mold opening phase (step 210).

Furthermore, those of skill in the art will recognize that the method described generally in steps 200 to 210 has been simplified with regards to when each of the fixed-target accumulator assembly 62 and variable-target accumulator assembly 66 are recharged or discharged. For example, one of the fixed-target accumulator assembly 62 and the variable-target accumulator assembly 66 may be recharging for a portion of one of the steps and discharging for another portion of the same step. The actual timing of the recharging and discharging of the fixed-target accumulator assembly 62 and variable-target accumulator assembly 66 will be dependent upon a number of factors including the molding application, the duration of the molding cycle and the sizing of clamp pump 54 and injection pump 56.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An injection molding system (20), comprising:
an extruder unit (22) for plasticizing a melt, the extruder unit (22) having an injection actuator (38) for injecting the melt into a mold assembly (40);
a clamping unit (24), the clamping unit (24) being configured to open and close the mold assembly (40) during a molding cycle; and
a power pack (46) for motivating hydraulic components of the injection molding system (20) during the molding cycle; wherein the power pack (46) includes:
a fixed-target accumulator assembly (62) operable to discharge hydraulic fluid at a fixed hydraulic pressure to at least one hydraulic component of the clamping unit (24) during the molding cycle;
a first pump being connected with the clamping unit (24), the first pump operable for charging the fixed-target accumulator assembly (62) to the fixed hydraulic pressure;
a variable-target accumulator assembly (66) operable to discharge the hydraulic fluid at a variable hydraulic pressure to the injection actuator (38) during the molding cycle; and
a second pump connected to the variable-target accumulator assembly (66), the second pump operable for charging the variable-target accumulator assembly (66) to the variable hydraulic pressure.

2. The injection molding system (20) of claim 1, wherein the variable-target accumulator assembly (66) includes a plurality of accumulators (64) charged to the variable hydraulic pressure.

3. The injection molding system (20) of claim 1, wherein the fixed-target accumulator assembly (62) includes a plurality of accumulators (64) charged to the fixed hydraulic pressure.

4. The injection molding system (20) of claim 1, wherein the first pump and the second pump are both driven by the same motor.

5. The injection molding system (20) of claim 1, wherein the first pump and the second pump are both driven by the same motor at a fixed speed.

6. The injection molding system (20) of claim 1, wherein the first pump is operable to have its displacement adjusted mechanically.

7. The injection molding system (20) of claim 1, wherein the second pump is to operable to have its displacement be adjusted electronically.

8. The injection molding system (20) of claim 1, wherein the at least one hydraulic component of the clamping unit (24) includes a mold stroke actuator (42).

9. The injection molding system (20) of claim 1, wherein the at least one hydraulic component of the clamping unit (24) includes a clamp actuator (44).

10. The injection molding system (20) of claim 1, wherein the at least one hydraulic component of the clamping unit (24) includes a clamp lock actuator (48).

11. The injection molding system (20) of claim 1, wherein the at least one hydraulic component of the clamping unit (24) includes at least two of a mold stroke actuator (42), a clamp actuator (44) and a clamp lock actuator (48).

12. The injection molding system (20) of claim 1, wherein the variable hydraulic pressure provided by the variable-target accumulator assembly (66) is adjusted by a closed-loop control at an interval of one of: between molding cycles and during one of the molding cycles.

13. The injection molding system (20) of claim 1, wherein a closed-loop control adjusts the variable hydraulic pressure provided by the variable-target accumulator assembly (66) based upon at least one of: position control, velocity control and pressure control.

14. A method for operating an injection molding system (20) during a molding cycle, comprising:
motivating an at least one hydraulic component of a clamping unit (24) of the injection molding system (20) using a first pump;
motivating an injection actuator (38) of an extruder unit (22) using a second pump;
discharging a hydraulic fluid stored at a fixed hydraulic pressure from a fixed-target accumulator assembly (62) to help motivate the at least one hydraulic component of the clamping unit (24) during the molding cycle;
discharging the hydraulic fluid stored at a variable hydraulic pressure from a variable-target accumulator assembly (66) to help motivate the injection actuator (38) during the molding cycle;
recharging the fixed-target accumulator assembly (62) to the fixed hydraulic pressure using the first pump when the first pump has spare pumping capacity during the molding cycle; and
recharging the variable-target accumulator assembly (66) to the variable hydraulic pressure using the second pump when the second pump has spare pumping capacity during the molding cycle.

15. The method of claim 14, wherein the variable hydraulic pressure provided by the variable-target accumulator assembly (66) is adjusted by a closed-loop control at an interval of one of: between molding cycles and during one of the molding cycles.
